(19) United States
(12) Patent Application Publication
(10) Pub. No.: US 2010/0291260 A1
(43) Pub. Date: Nov. 18, 2010

(54) USE OF CACAO POLYPHENOLS IN BEER PRODUCTION

(75) Inventor: Herwig Bernaert, Zurich (CH)

Correspondence Address: HOXIE & ASSOCIATES LLC, 75 MAIN STREET , SUITE 301, MILLBURN, NJ, 07041, US

(73) Assignee: BARRY CALLEBAUT AG, Zurich (CH)

(21) Appl. No.: 12/161,312

(22) PCT Filed: Jan. 15, 2007
(86) PCT No.: PCT/EP2007/000290

§ 371 Date: Jul. 26, 2010

(30) Foreign Application Priority Data
Jan. 17, 2006 (EP) PCT/EP2006/000375
Apr. 10, 2006 (EP) PCT/EP2006/003268

(51) Int. Cl. C12C 5/02; C12C 12/00

(52) U.S. Cl. 426/16; 426/542

(57) ABSTRACT

The present invention relates to a solvent-derived, cocoa extract comprising between 25 and 65% by weight of polyphenols, and uses thereof for improving a beer production process and the resulting beer product. The invention further relates to a method for improving a beer production process as well as the beer product resulting from it. The invention further relates to a beer product with improved quality such as enhanced colloidal, taste and flavor stability. The invention also provides a beer with exogenous polyphenols and a beer comprising at least one cocoa polyphenol. Furthermore, the present invention includes a use of exogenous polyphenols as process enhancer and a use of cocoa for enhancing filtration processes.

### FIELD OF THE INVENTION

The invention relates to a method for improving a beer production process as well as the beer product resulting from it. The invention further relates to a beer product with improved quality such as enhanced colloidal, taste and flavor stability. The invention also provides a beer with exogenous polyphenols and a beer comprising at least one cocoa polyphenol. Furthermore, the present invention includes a use of exogenous polyphenols as process enhancer and a use of cocoa for enhancing filtration processes. The present invention further relates to a cocoa extract and its use in the beer production process.

### BACKGROUND OF THE INVENTION

The present invention relates to the use of exogenous polyphenols to improve the beer production process and the resulting beer.

The brewing process consists of nine key components: malting, milling, mashing, brewing, cooling, fermentation, racking and finishing. Malting is the process of transferring the barley into malt and unlocks starches hidden in the barley. Milling is the cracking of the grains to allow them to absorb water. The milled grain is dropped into warm water and during mashing the starches are converted to sugars that can be fermented. During lautering the sugar rich water is strained through the bottom of the mash and is then called wort. This wort goes to the brew kettle where it is brought to a boil and undergoes many technical and chemical reactions. At this stage different types of hops are added for bitterness or aroma. Subsequently the wort is filtered to remove the hops and cooled to a point where yeast can safely be added. In the next step the wort sugars are fermented by the yeast to alcohol. After fermentation the brewer moves or ‘racks’ the green beer in the conditioner tank where it is maintained to complete the ageing process. Finally the beer is filtrated and carbonated and can then be stored until it becomes bottled or kegged.

Clearly producing beer is a time consuming and expensive process. Therefore brewers are always seeking to optimize the process, speed up the most time consuming steps and/or improve the end product. For example, GB01169633 discloses an extraction apparatus in which the wort is separated from the grains in such a way that the wort extracts as much as possible desired compounds from the grains in the mash. GB01202124 provides an apparatus in which malt moistened with water is ground to yield particles and sifted to yield three meal fractions. GB01179482 proposes a process for fermenting and ageing malt beverages that can be carried out under automatic control with the aid of monitoring instruments. And in GB01165328 a process and apparatus is described which allows the fermentation to occur on a continuous base.

Also a lot of attempts have been made to improve the beer itself. GB1212437 discloses the use of yeast hybrids to obtain a super-fermented potable alcoholic liquid or beer. Other examples are GB01174618 and GB01174619, which claim the use of the enzyme amyloglucosidase respectively for producing beers of low carbohydrate contents and for sweetening beers. Improving the stability by reducing haze in beer is achieved by using a silica xerogel and is described in WO2005066326 and GB01279250.

The flavor stability of beer is currently one of the most important quality aspects in the brewing industry. Flavor deterioration coincides with an increase in and a release of alkanals-alkenals as final products of auto-oxidation and enzymatic degradation of lipids and with a rise in Strecker aldehydes. Oxidative reactions on iso-a-acids, especially on the less-stable trans-isomers, result in a lower, less fine, and harsher bitterness. Next to the lipoxygenase (LOX) content, the antioxidant power of the malt and the mashing-in conditions are important parameters affecting the flavor staling of beer. However, in most brewing trials, the reducing capacity of the malt and other raw materials seems insufficient to prevent these adverse effects. Therefore, much attention is paid to the development and implementation of antioxidative beer production systems and to the potential of both endogenous and exogenous antioxidants as flavor stabilizers.

Synthetic antioxidants could be used but, since studies have provided evidence for their role in carcinogenesis, natural antioxidants are preferred. Examples of antioxidants are the vitamins E and C as well as polyphenols, which are present in grape and wine in large amounts. Polyphenols are widely distributed in nature and high concentrations of these compounds are found in for example onions, apples, red wine, olives, broccoli, parsley, celery, tea, Ginkgo biloba, cocoa beans, grape and grape seeds and berries.

Polyphenols have attracted much attention recently due to their role in prevention of illnesses such as heart diseases and diseases of cardiovascular system whose causes are in the oxidation of LDL. The antiviral functioning of polyphenols is very well known. Diseases and even ageing can occur due to molecular damages caused by harmful free radicals, side metabolic products, which however, can be neutralized by antioxidants.

Polyphenols play a vital role in the growth and propagation of plants and protect plant tissue from damage. They neutralize free radicals and thus protect biologically vital molecules from oxidation. Polyphenols are a part of a complex immunity system, which can be acquired in the tissues under stress. The plants cannot, contrary to animals, synthesize antibodies but they can produce numerous substances, called phytoalexins. Those are secondary metabolites, which inhibit and kill pathogenic organisms. In addition, polyphenols protect plants against insects and herbivorous mammals.

Polyphenols can be classified into the categories phenolic acids, accounting for about one third of the total intake of polyphenols, and flavonoids, accounting for the remaining two thirds. Flavonoids are further subdivided into several categories. Anthocyanins and anthocyanidins are a large water-soluble pigment group. Isoflavones have an influence on bone health among postmenopausal women, together with some weak hormonal effects. They can also influence transcription and cell proliferation, modulate enzyme activities as well as signal transduction and have antioxidant properties. Proanthocyanidins are complex polyphenols with reducing capacity and the ability to chelate metal ions. Because of their polymeric nature they differ from other polyphenols by having a high affinity for proteins, a likely limited absorption through the gut barrier and the metabolites formed by the colonic microflora. Other subclasses are catechins or flavanols, flavones, flavonols and flavanones.

Flavanols (flavan-3-ols) and flavanol oligomers and polymers (proanthocyanidins) are of profound significance because they have been proven to possess powerful antioxidant properties and other beneficial biological activities. With regard to flavanol applications in food technology, early studies showed that catechin, along with other polyhydroxy flavonoids, may be a potent edible oil antioxidant. Catechin has also been found effectively to stabilize fish oils against spontaneous or Fe²⁺-catalysed oxidation, while epicatechin was demonstrated to be a superior antioxidant for canola oil compared with synthetic butylated hydroxyanisole and butylated hydroxytoluene. Studies carried out on canola oil, employing green tea extracts rich in epicatechin, epicatechin 3-O-gallate, epigallocatechin and epigallocatechin 3-O-gallate as antioxidants, also demonstrated the higher ability of flavanols to stabilize oils against oxidation compared with BHT.

The brightness of the wort is of outmost importance for the taste and flavor stability of the beer and may be influenced by the presence of proteins combined with secondary plant products known as flavanols. Flavanols are naturally occurring polyphenolic compounds in barley malt and hops, which co-precipitate with malt proteins during mashing. As a result the wort is brighter and lautering is easier.

EP01306402 and WO03035723 disclose a product with immobilized polyphenols which can be used as an antioxidant, a radical scavenger or an antibacterial and for example more specifically in the clarification and stabilization of beverages like beer. Because beer production is a time consuming and expensive process, brewers are always seeking to optimize the process and/or speed up the most time consuming steps. Also a lot of attention is paid to improve the stability of the beer product so that it can be preserved longer. The immobilized polyphenols described in EP01306402 and WO03035723 could be used during the brewing process as additional antioxidants, but this solution would be very expensive and would require major adaptations to the process.

### AIMS OF THE INVENTION

The present invention aims to address the needs of the art and particularly provides a method for improving the beer production process as well as the beer product resulting from it.

A further aim of the invention is to provide an extract, preferably a cocoa extract, which is adapted to be used for improving the beer production process as well as the beer product resulting from it.

It is the aim of the present invention to provide a method, resulting in a faster beer production process as well as in a beer with enhanced colloidal, taste and flavor stability, by adding exogenous polyphenols at different stages in the brewing process. Preferably, it is the aim of the present invention to provide a method for improving a beer production process by adding a cocoa extract as defined herein during one or more stages of the brewing process.

Another aim of the invention is to provide a beer product with improved colloidal, taste and flavor stability obtainable by addition of exogenous polyphenols at different stages of the brewing process. Preferably, it is the aim of the present invention to provide a beer product with improved colloidal, taste and flavor stability obtainable by addition of a cocoa extract as defined herein during one or more stages of the brewing process.

The present invention further aims to provide an improved cocoa extract and a method for preparing such cocoa extract.

### SUMMARY OF THE INVENTION

The present invention, which addresses the needs following from the art, provides a method for improving a beer production process and the resulting beer product. This method comprises an addition of exogenous polyphenols prior to or at mashing and lautering and/or post fermentation which results in a faster beer brewing process, in particular a decrease of the needed filtration time. Another result is an improved colloidal, taste and flavor stability of the resulting beer.

The present invention also includes a beer product resulting from this method characterized in that the beer has an improved quality such as an enhanced colloidal, taste and flavor stability. The invention provides a beer with exogenous polyphenols and a beer comprising at least one cocoa polyphenol.

Furthermore, the present invention includes a use of exogenous polyphenols as process enhancer and the use of exogenous polyphenols, preferably derived from cocoa for improving a beer production process and the resulting beer. Use of cocoa or products derived from it for enhancing filtration processes is also provided for by the invention.

In the invention further relates to a solvent-derived, cocoa extract and uses thereof for improving a beer production process and the resulting beer product. More in particular, the invention relates to the use of a cocoa extract for improving wort filtration during the beer production process and for reducing the wort filtration time during the beer production process.

The invention also relates to a method for preparing a cocoa extract as defined herein.

The invention further provides a method for improving a beer production process and the resulting beer product which comprises addition of a cocoa extract as defined herein in one or more stages of the brewing process. This method preferably comprises the addition of a cocoa extract as defined herein prior to or at mashing and lautering and/or post fermentation which results in a faster beer brewing process, in particular a decrease of the needed filtration time. Another result is an improved colloidal, taste and flavor stability of the resulting beer.

Further provided is a beer product resulting from this method characterized in that the beer has an improved quality such as an enhanced colloidal, taste and flavor stability. The invention provides a beer having an amount of cocoa polyphenols which is preferably comprised between 0.1 and 100 ppm; an amount of theobromine which is below 5 ppm, preferably below 3 ppm, and more preferably below 1 ppm, and an amount of xanthines which is below 5 ppm, preferably 3 ppm and more preferably below 1 ppm.

Those skilled in the art will immediate recognize the many other effects and advantages of the present method and the cocoa extract and the numerous possibilities for end uses of the present invention from the detailed description and examples provided below.

### BRIEF DESCRIPTION OF THE DRAWINGS

FIG. 1 describes the path of extract, pressure, volume and flow in function of the time during the lautering process of the reference beer.

FIG. 2 describes the path of extract, pressure, volume and flow in function of the time during the lautering process of the cacpfbm beer.

FIG. 3 shows the path of extract, alcohol % and pH in function of the time during fermentation of reference beer 1.

FIG. 4 shows the path of extract, temperature, alcohol % and pH in function of the time during fermentation of reference beer 2.

FIG. 5 describes the path of extract, alcohol % and pH during fermentation time of the cacpfbm beer 1.

FIG. 6 describes the path of extract, temperature, alcohol % and pH during fermentation time of the cacpfbm beer 2.

FIG. 7 displays a multi-chromatogram of the reference beer (chromatogram a) and beer cacpfbm 20 (chromatogram b).

The latter is also shown in FIG. 8.

FIGS. 9, 10, 11 and 12 display the DAD-spectra of the cacao polyphenols representing flavonoid skeletons and more precise,

FIGS. 11 and 12 show respectively a catechine and epicatechine.

FIG. 13 shows the degradation of bitterness during beer ageing.

FIG. 14 describes the path of extract, pressure, volume and flow in function of the time during the lautering process of a reference beer.

FIG. 15 describes the path of extract, pressure, volume and flow in function of the time during the lautering process of a calpel.pf beer.

FIG. 16 shows the path of extract, alcohol % and pH in function of the time during fermentation of a reference beer 1.

FIG. 17 shows the path of extract, temperature, alcohol % and pH in function of the time during fermentation of a reference beer 2.

FIG. 18 describes the path of extract, alcohol % and pH during fermentation time of a calpel.pf beer 1.

FIG. 19 describes the path of extract, temperature, alcohol % and pH during fermentation time of a calpel.pf beer 2.

FIG. 20 describes the path of extract, pressure, volume and flow in function of the time during the lautering process of a reference beer.

FIG. 21 describes the path of extract, pressure, volume and flow in function of the time during the lautering process of a calco2.pf beer.

FIG. 22 shows the path of extract, alcohol % and pH in function of the time during fermentation of a reference beer 1.

FIG. 23 shows the path of extract, temperature, alcohol % and pH in function of the time during fermentation of a reference beer 2.

FIG. 24 describes the path of extract, alcohol % and pH during fermentation time of a calco2.pf beer 1.

FIG. 25 describes the path of extract, temperature, alcohol % and pH during fermentation time of a calco2.pf beer 2.

FIG. 26 describes the path of extract, pressure, volume and flow in function of the time during the lautering process of a reference beer.

FIG. 27 describes the path of extract, pressure, volume and flow in function of the time during the lautering process of a caliso.pf beer.

FIG. 28 shows the path of extract, alcohol % and pH in function of the time during fermentation of a reference beer 1.

FIG. 29 shows the path of extract, temperature, alcohol % and pH in function of the time during fermentation of a reference beer 2.

FIG. 30 describes the path of extract, alcohol % and pH during fermentation time of a caliso.pf beer 1.

FIG. 31 describes the path of extract, temperature, alcohol % and pH during fermentation time of a caliso.pf beer 2.

FIG. 32 illustrates a supercritical extractor that can be used according to the present invention for preparing an improved cocoa extract having a lower content of xanthines and/or theobromine.

### DETAILED DESCRIPTION OF THE INVENTION

Beer production is a time consuming and expensive process. Therefore brewers are always seeking to optimize the process and/or speed up the most time consuming steps. Another aim of beer producers is to improve the stability of the beer product so that it can be preserved longer.

The present invention provides a method for improving the beer production process and relates to the addition of exogenous polyphenols in one or more stages of the brewing process. The total amount of polyphenols can become administered all at once, over some time interval or during the whole process in a periodical or continuous way.

Addition of exogenous polyphenols prior to or at mashing and lautering is found to result in an easier wort lautering and brighter worts. This leads to a higher wort filtration performance resulting in a decrease of the filtration time. Since filtration is one of the most time consuming process steps, the present invention competes with the need for speeding up the beer brewing process.

It is also the finding of the present invention that addition of exogenous polyphenols prior to or at mashing and lautering and/or post fermentation improves the colloidal, taste and flavor stability of the beer product obtainable by this method. The beer, which is brighter, shows an increase of simple polyphenols compared to complex polyphenols and a stabilization of the bitterness compounds, which results in improvement of the colloidal stability as well as an increase of the flavor and taste stability.

The polyphenols used in the present invention are derived from a polyphenol rich source different from hop or malt. Polyphenol rich is here defined as a weight % of at least 0.1% of total polyphenols according to the source. Synthetic antioxidants could be used but, since studies have provided evidence for their role in carcinogenesis, natural antioxidants are preferred. Polyphenols are widely distributed in nature and high concentrations of these compounds are found in for example onions, apples, red wine, olives, broccoli, parsley, celery, tea, Ginkgo biloba, cocoa beans, grape and grape seeds and berries. The subclass of polyphenols most important for the present invention is the class of flavonoids, more preferably catechins or flavanols. These compounds have been proven to possess powerful antioxidant properties and are found in high concentrations in red wine, tea and cocoa beans. As a result, the present invention discloses the use of polyphenols derived preferably from red wine and tea and more preferably from cocoa.

It is noted that the terms “cocoa” and “cacao” as used herein are considered as synonyms.

“Beer”, as used herein, refers to any beverage produced through the fermentation of starch-based material and which is not distilled after fermentation. It includes beverages produced by the processes of malting, milling, mashing, brewing, cooling, fermentation, racking and finishing as described above. Commonly, a source of starch is malt. Examples of beers produced according to the present invention include, but are not limited to ale, lager, bitter, light and dark beers, Iambic beers, and pilsner lager. It includes low-or no-alcohol forms of the beverage.

An embodiment of the present invention includes the use of polyphenols derived from a cacao extract and another embodiment relates to the use of a cacao polyphenol powder. The weight % of polyphenols in the cacao extract, as liquid or powder, is described in a further embodiment and is 10 to 85% polyphenols, preferably 15 to 65% and more preferably 35%. A method for obtaining cocoa bean polyphenol extracts is disclosed in WO0214251, which is hereby incorporated by reference.

Another embodiment of the present invention relates to the type of polyphenols. The added polyphenols consist essentially of flavonoids, preferably catechins or flavanols, because studies have found out that these compounds possess powerful antioxidant properties.

Also the actual amount of the exogenous polyphenols added to the beer liquor is included in two embodiments. The amount, expressed as mg exogenous polyphenols per liter of brewing water, added prior to or at mashing ranges from 1 to 100 ppm, preferably from 25 to 75 ppm and more preferably 50 ppm. The amount added prior to or at lautering ranges from 1 to 75 ppm, preferably 20 to 50 ppm and more preferably 25 ppm. The amount exogenous polyphenols added post fermentation is between 1 and 100 ppm, and preferably between 10 and 20 ppm.

The present invention also discloses the product resulting from the method previously described. This beer product, yielded from a brewing process characterized in that exogenous polyphenols were added in one or more process steps, has an improved quality such as an enhanced colloidal, taste and/or flavor stability.

In one embodiment of the invention the product is obtainable by adding polyphenols derived from a polyphenol rich source in the process. The polyphenol rich source is characterized in that it contains at least 0.1% (weight %) of polyphenols according to the source. The sources used by preference are red wine and/or tea, and more preferably cocoa.

In a preferred embodiment the present invention includes the product obtainable by addition of a cacao extract as source of polyphenols. In a further preferred embodiment of the invention the cacao extract is administered as a cacao polyphenol powder. The cacao extract, as liquid or powder, comprises 10 to 85% polyphenols, preferably 15 to 65% and more preferably 35% or 50%.

The present invention discloses a beer comprising an amount of 0.1 to 100 ppm exogenous polyphenols and preferably 1 to 50 ppm. In a preferred embodiment, this beer is characterized in that said exogenous polyphenols are at least partly derived from cocoa. Another embodiment of the present invention discloses a beer characterized in that the resulting beer contains at least one polyphenol which isn't present in a beer brewed in the traditional way. The first polyphenol on the chromatogram, detection at 280 nm, of the claimed beer product, is specific for cacao and isn't present in, for example, hop or malt. This way the beer product according to the present invention can be distinguished from other beers by means of chromatographic analysis.

The present invention also provides a use of an exogenous polyphenol as process enhancer. In a further embodiment the use of exogenous polyphenols is described for improving a beer production process and its resulting beer product.

An embodiment of the invention includes the use of cocoa and/or products derived from cocoa for enhancing filtration processes, used for example for clarification and/or stabilization of beverages like beer.

In a further aspect, the invention relates to a solvent-derived, cocoa extract comprising polyphenols and uses thereof. The term ‘solvent-derived’ as used herein refers to an extract of cocoa that is obtained using as solvent a mixture of water and an organic solvent (e.g. a water miscible organic solvent, an alcohol, ethanol, acetone, 2-butanol, or 2-propanol) in the extraction procedure.

In a preferred embodiment, the invention relates to solvent-derived, cocoa extract comprising between 25 and 75%, more preferably between 25 and 65° A, by weight of polyphenols analysed by Folin Ciocalteu method and expressed as epicatechin, whereby said polyphenols comprise between 5 and 15° A) by weight of the extract of monomers and more than 20% by weight of the extract of one or more oligomers. In a preferred embodiment, the cocoa extract comprises between 35 and 65% by weight of polyphenols, and even more preferred between 40 and 55% by weight of polyphenols. In an example, the cocoa extract comprises 40, 45, 50, or 60% by weight of polyphenols. In another preferred embodiment, the cocoa extract comprises between 5 and 10° A) by weight of the extract of (polyphenol) monomers, and for instance 5.5, 6, 6.5, 7, 7.5, 8, 8.5, 9 or 9.5% by weight of the extract of monomers. In yet another preferred embodiment, the extract according to the invention comprises more than 10% by weight by weight of the extract, and preferably more than 15%, more than 20%, more than 25% or more than 30% by weight of the extract of one or more (polyphenol) oligomers.

In a further embodiment, the cocoa extract comprises monomers, whereby said monomers comprise between 5 and 15% by weight of the extract of epicatechin and between 0.5 and 5% by weight of the extract of catechin. In a preferred embodiment, the monomers present in the cocoa extract comprise between 6 and 10%, and for instance, 6.5, 7, 7.5, 8, 8.5, 9, 9.5 by weight of the extract of epicatechin, and between 1 and 4° A), and for instance, 1.5, 2, 2.5, 3, 3.5° A) by weight of the extract of catechin.

In another embodiment, the invention relates to a cocoa extract comprising oligomers wherein said oligomers comprise dimer(s), trimer(s), tetramer(s), pentamer(s), hexamer(s), heptamer(s), octamer(s), nonamer(s) and/or decamer(s). In another embodiment, said oligomers further comprise oligomers having more than ten monomer units and may comprise undecamer(s), dodecamer(s), tridecamer(s), tetradecamer(s), pentadecamer(s), hexadecamer(s), heptadecamer(s), octadecamer(s), nonadecamer(s), eicosmer(s), etc. The term “oligomers” is used herein to refer to compounds having more than one monomer unit.

In a preferred embodiment, the cocoa extract according to the invention comprises (% by weight of the extract): between 5 and 15% by weight, and preferably between 6 and 10% by weight of dimer(s), between 5 and 15% by weight, and preferably between 6 and 10% by weight of trimer(s), between 2.5 and 10% by weight, and preferably between 4 and 9% by weight of tetramer(s), between 2.5 and 10% by weight, and preferably between 4 and 9% by weight of pentamer(s), between 2.5 and 10% by weight, and preferably between 4 and 9% by weight of hexamer(s), between 0.5 and 5% by weight, and preferably between 1 and 3% by weight of heptamer(s), between 0.5 and 5% by weight, and preferably between 0.5 and 3% by weight of octamer(s), between 0.5 and 5% by weight, and preferably between 1 and 3% by weight of nonamer(s), and/or between 0.1 and 3% by weight, and preferably between 0.1 and 1% by weight of decamer(s). In a further embodiment, the invention relates to a cocoa extract further comprising more than 3% by weight of the extract, and preferably more than 5% by weight of the extract, and even more preferred more than 8% by weight of the extract of one or more oligomers having more than 10 monomer units, and including but not limited to undecamer(s), dodecamer(s), tridecamer(s), tetradecamer(s), pentadecamer(s), hexadecamer(s), heptadecamer(s), octadecamer(s), nonadecamer(s), eicosmer(s), etc. . . .

The extract according to the present invention is a solvent-derived extract, wherein said solvent is ethanol and water, acetone and water, 2-butanol and water, or 2-propanol and water, and preferably ethanol and water. The extract according to the present invention can comprise a non-purified as well as a purified and/or concentrated extract.

The present cocoa extract is further characterized in that it may comprise additional components such as but not limited to ash(es), one or more alkaloid(s), one of more fat(s), one or more sugar(s) and/or sugar alcohol(s), one or more protein(s), one or more fiber(s) and moisture, e.g. water.

In one embodiment, the invention relates to a cocoa extract, wherein said extract further comprises between 5 and 15%, and preferably between 8 and 12% by weight of one or more alkaloid(s). Preferably said alkaloids comprise, but are not limited to xanthines and/or theobromines. In a preferred embodiment, the present invention provides a cocoa extract containing less than 10% and preferably less than 5% by weight of xanthines. In another embodiment, the invention relates to a cocoa extract containing less than 10% and preferably less than 5% by weight of theobromine.

In another embodiment, the invention relates to a cocoa extract, wherein said extract further comprises between 5 and 15% by weight, and preferably between 8 and 12% by weight of one or more sugar(s) and/or sugar alcohol(s). Preferably said sugars may comprise but are not limited to fructose and/or glucose. Said sugar alcohol may comprise but is not limited to mannitol.

In yet another embodiment, the invention relates to a cocoa extract, wherein said extract further comprises between 15 and 25%, and preferably between 17 and 21% by weight of one or more protein(s). The term proteins may include but is not limited to peptides, oligopeptides, polypeptides, amides, polyamides, enzymes, etc. . . .

In another embodiment, the invention relates to a cocoa extract, wherein said extract further comprises between 3 and 10%, and preferably between 3 and 8% by weight of one or more fiber(s). Preferably said fibers may comprise but are not limited to pectin, cellulose, hemi-cellulose and/or lignin.

In yet another embodiment, the invention relates to a cocoa extract, wherein said extract further comprises between 0.5 and 5%, and preferably between 1 and 3% by weight of one or more fats. Preferably said fat consists of cocoa fat.

In an example the present invention relates to a cocoa extract comprising polyphenols as defined herein and at least one component selected from the group comprising ash, alkaloids, fats, sugars, proteins and/or fibers. These components may be present in the extract in an amount as indicated above.

In one embodiment the present invention relates to a cocoa extract comprising polyphenols and at least one alkaloid. In another embodiment, the present invention relates to a cocoa extract comprising polyphenols and at least one fat. In another embodiment, the present invention relates to a cocoa extract comprising polyphenols and at least one sugar and/or sugar alcohol. In another embodiment, the present invention relates to a cocoa extract comprising polyphenols and at least one protein. In another embodiment, the present invention relates to a cocoa extract comprising polyphenols and at least one fiber. In another embodiment, the present invention relates to a cocoa extract comprising polyphenols, at least one alkaloid, and at least one fat. In another embodiment, the present invention relates to a cocoa extract comprising polyphenols, at least one alkaloid, and at least one sugar and/or sugar alcohol. In another embodiment, the present invention relates to a cocoa extract comprising polyphenols, at least one alkaloid, and at least one protein. In another embodiment, the present invention relates to a cocoa extract comprising polyphenols, at least one alkaloid, and at least one fiber. In yet another embodiment, the present invention relates to a cocoa extract comprising polyphenols, at least one alkaloid, at least one sugar and/or sugar alcohol, and at least one fat. In another embodiment, the present invention relates to a cocoa extract comprising polyphenols, at least one alkaloid, at least one sugar and/or sugar alcohol, and at least one protein. In yet another embodiment, the present invention relates to a cocoa extract comprising polyphenols, at least one alkaloid, at least one sugar and/or sugar alcohol, and at least one fiber. In still another embodiment, the present invention relates to a cocoa extract comprising polyphenols, at least one alkaloid, at least one sugar and/or sugar alcohol, at least one protein, and at least one fat. In another embodiment, the present invention relates to a cocoa extract comprising polyphenols, at least one alkaloid, at least one sugar and/or sugar alcohol, at least one protein, and at least one fiber. In another embodiment, the present invention relates to a cocoa extract comprising polyphenols, at least one alkaloid, at least one sugar and/or sugar alcohol, at least one protein, at least one fat, and at least one fiber. In another embodiment, the present invention relates to a cocoa extract comprising polyphenols, at least one sugar and/or sugar alcohol, and at least one fat. In another embodiment, the present invention relates to a cocoa extract comprising polyphenols, at least one sugar and/or sugar alcohol, and at least one protein. In another embodiment, the present invention relates to a cocoa extract comprising polyphenols, at least one sugar and/or sugar alcohol, and at least one fiber. In another embodiment, the present invention relates to a cocoa extract comprising polyphenols, at least one protein, and at least one fat. In another embodiment, the present invention relates to a cocoa extract comprising polyphenols, at least protein, and at least one fiber. In another embodiment, the present invention relates to a cocoa extract comprising polyphenols, at least one fat, and at least one fiber. In another embodiment, the present invention relates to a cocoa extract comprising polyphenols, at least one sugar and/or sugar alcohol, at least one fat, and at least one fiber. In yet another embodiment, the present invention relates to a cocoa extract comprising polyphenols, at least one protein, at least one fat, and at least one fiber. In yet another embodiment, the present invention relates to a cocoa extract comprising polyphenols, at least one sugar and/or sugar alcohol, at least one protein, and at least one fat. In another embodiment, the present invention relates to a cocoa extract comprising polyphenols, at least one sugar and/or sugar alcohol, at least one protein, and at least one fiber. These components may be present in the extract in an amount as indicated above.

The present cocoa extract may be in any type of formulation, but is preferably in a dry or lyophilized form. In an example, the present extract may be in the form of a powder, an uncompressed powder, a semi-compressed powder, a granule, a pellet, a tablet, a granulate, a small particle, a capsule, etc. Preferably, the present cocoa extract is in the form of a powder, a granule, or pellet, and most preferably of a granule. It shall be clear that a skilled person will understand what is meant with these types of formulations.

The present cocoa extract can be easily packed and stored, preferably in a cool and dry area, and protected against light and air. The present cocoa extract has a shelf life of at least 5 years.

In another aspect, the invention provides a method for preparing a cocoa extract according to the present invention. In a preferred embodiment, the method further comprises the step of extraction of the obtained cocoa extract with CO₂ and a suitable co-solvent (e.g. ethanol)

In yet another aspect, the invention relates to a method for improving a beer production process and the resulting beer product which comprises addition of a cocoa extract as defined herein in one or more stages of the brewing process.

In yet another embodiment, the invention provides a method for improving wort filtration during the beer production process, comprising addition of a cocoa extract as defined herein in one or more stages of the brewing process. Preferably the present invention relates to a method for reducing the wort filtration time during the beer production process with at least 10%, and preferably with at least 15%, 20% or even 25%.

In still another embodiment, the invention provides a method for preparing beer having a reduced amount of xanthines and theobromine, comprising addition of a cocoa extract as defined herein in one or more stages of the brewing process. Preferably a method is provided in accordance with the present invention for preparing beer having an amount of theobromine which is below 5 ppm, preferably below 3 ppm, and more preferably below 1 ppm. In yet another preferred embodiment, a method is provided in accordance with the present invention for preparing beer having an amount of xanthines which is below 5 ppm, preferably below 3 ppm, and more preferably below 1 ppm.

In accordance with the present method, the cocoa extract may be added prior to or at mashing and lautering. The cocoa extract may also be added post fermentation. In another embodiment, the method comprises addition of a cocoa extract as defined herein prior to or at mashing and lautering, and post fermentation.

The present invention further relates to a beer product, preferably a beer, obtainable by the present method. The beer is characterized in that said beer product has an improved quality such as an enhanced colloidal, taste and/or flavor stability. Moreover, the beer product has an amount of 0.1 to 100 ppm, and preferably of 1 to 50 ppm cocoa polyphenols. In another preferred embodiment, the beer according to the invention has an amount of theobromine which is below 5 ppm, preferably below 3 ppm, and more preferably below 1 ppm. In yet another preferred embodiment, the beer according to the invention has an amount of xanthines which is below 5 ppm, preferably below 3 ppm, and more preferably below 1 ppm.

The present cocoa extract as defined herein is advantageously used for improving a beer production process and the resulting beer product. Preferably, the present cocoa extract is used by adding prior to or at mashing and lautering during the beer production process. Alternatively or in combination therewith the present cocoa extract is used by adding it post fermentation during the beer production process. In a preferred embodiment, the present invention relates to the use of a cocoa extract as defined herein for improving the lautering process during the beer production process, and preferably for improving wort filtration during the beer production process.

Preferably the present cocoa extract as defined herein is used for accelerating wort filtration during the beer production process. In an embodiment the present cocoa extract as defined herein is used for reducing the wort filtration time during the beer production process with at least 10%, and preferably with at least 15%, 20% or even 25%. As will be understood by a person of skill in the art, these percentages may refer to a faster wort filtration. In accordance with the invention it is thus possible to perform more filtrations and thus more brewings over a same time. These percentages may also indicate that in a same time a higher amount of grains may be used in the process and thus that an increased production capacity can be obtained. The term “grains” as used herein is intended to refer to all types of grains which are suitable for being applied during beer production. A person of skill in the art will understand what is meant with this term. Non-limitative examples of grains may comprise malt, wheat, barley, etc. . . .

In another embodiment, the present cocoa extract as defined herein is used for preparing beer product having a reduced amount of xanthines and/or theobromines, and preferably for preparing a beer having an amount of theobromine which is below 5 ppm, preferably below 3 pm, and more preferably below 1 ppm, and having an amount of xanthines which is below 5 ppm, preferably below 3 ppm, and more preferably below 1 ppm.

In a preferred embodiment, the present cocoa extract as defined herein is used as follows. The present cocoa extract as defined herein is added directly to brewing water, during the mashing-in process. Suitable dosages of the present cocoa extract may include of between 35 to 310 mg of an extract comprising between 25 and 65% by weight of polyphenols per kg of grains. Preferably, first a pre-solution of the present cocoa extract is made in hot water of for instance about 70 to 80° C., by adding the cocoa extract to hot water, followed by mixing. Preferably the extract is slowly added to the hot water to avoid clumping. The pre-solution is then added to the brewing water or injected proportionally into the brewing water during the mashing-in process. In an example, the present cocoa extract comprising about 50% by weight of polyphenols is applied at an amount of 180 mg per kg of grains. A 3% pre-solution of the extract is prepared by slowly adding 30 gram of the present cocoa extract to 1 liter of said water, followed by mixing. The pre-solution may then be added to the brewing water or injected proportionally into the brewing water during the mashing-in process. 6 liters of pre-solution (3%) per ton of grains may be used.

It will be clear from the present invention, that the cocoa extract as defined herein may also by advantageously used for improving other types of filtration processes.

The following examples illustrate products of the present invention, in particular beers resulting from a brewing process with cacao polyphenols added at different stages of the process.

### EXAMPLES

### Example 1

### Example of a Cocoa Extract According to the Present Invention

The present example illustrates an embodiment of a composition of a cocoa extract according to the present invention. The extract consists of 47.5% by weight of polyphenols, 3.5% by weight of ash, 10% by weight of alkaloids, preferably xanthines, 3% by weight of moisture, 1.5% by weight of fat, 10% by weight sugars and/or sugar alcohols, 20.5% by weight of proteins, and 4% by weight of fibers. A preferred composition of the polyphenols in said extract comprises, as expressed on the cocoa extract (100 gr), 8.2% of monomers, 7.1% of dimers, 7.3% of trimers, 4.4% of tetramers, 3.8% of pentamers, 3.5% of sextamers, 1.4% of septamers, 0.9% of octamers, 1.1% of nonamers, 0.4% of decamers, 9.5% of >decamers (i.e. oligomers having more than 10 monomer units as defined herein). The monomers comprise for example 7.15% by weight (based on the cocoa extract) of epicatechin and 1.04% by weight (based on the cocoa extract) of catechin.

### Example 2

### Brewing Trial on Pilot Scale

A pilot brew was prepared with the addition of 143 mg/l of cacao polyphenol powder in the brewing water. For the sparging during wort lautering, 71 mg/l of the powder was added. The concentration of polyphenols in the received powder was (according to analyses of Brunswick laboratories, Thatcher lane, Wareham, USA) 35%. The actual concentration of polyphenols in the brewing liquors was respectively 50 en 25 mg polyphenols per litre of brewing water.

After the wort fermentation, the green beer was divided in 3 parts with an extra addition of respectively no, 10 ppm and 20 ppm cacao polyphenols in the beer.

Also a reference beer was produced without the addition of extra polyphenolic compounds. Four beers were obtained and the codes are explained in table 1.

TABLE 1
The additions of cacao polyphenols during brewing at pilot scale

| | addition cacao | addition | addition |
|---|---|---|---|
| | polyphenols | cacao polyphenols | cacao polyfenols |
| code | at mashing in | at sparging | post fermentation |
| REF | — | — | — |
| CACPFBM 0 | 50 mg/l | 25 mg/l | — |
| CACPFBM 10 | 50 mg/l | 25 mg/l | 10 mg/l |
| CACPFBM 20 | 50 mg/l | 25 mg/l | 20 mg/l |

### Analysis Polyphenolic Extract

A photometric test was used to evaluate the amount of polyphenols in the cacao extract. In an ethanol/water solution (1/1), 50 mg powder was dissolved and used for further analysis. The results were shown in table 2.

TABLE 2
Analysis of polyphenolic extract

| | concentration | % composition powder |
|---|---|---|
| | in the solution (mg/l) | g/100 g powder |
| total polyphenols | 255.43 | 51.1 |
| flavanoïds | 75.70 | 15.1 |
| proanthocyodins | 60.46 | 12.1 |

Based on our photometric analysis, the polyphenolic content of the powder was 51%. For the additions however the given content of 35% of polyphenols was used.

### Example 2.1

### Beer Production

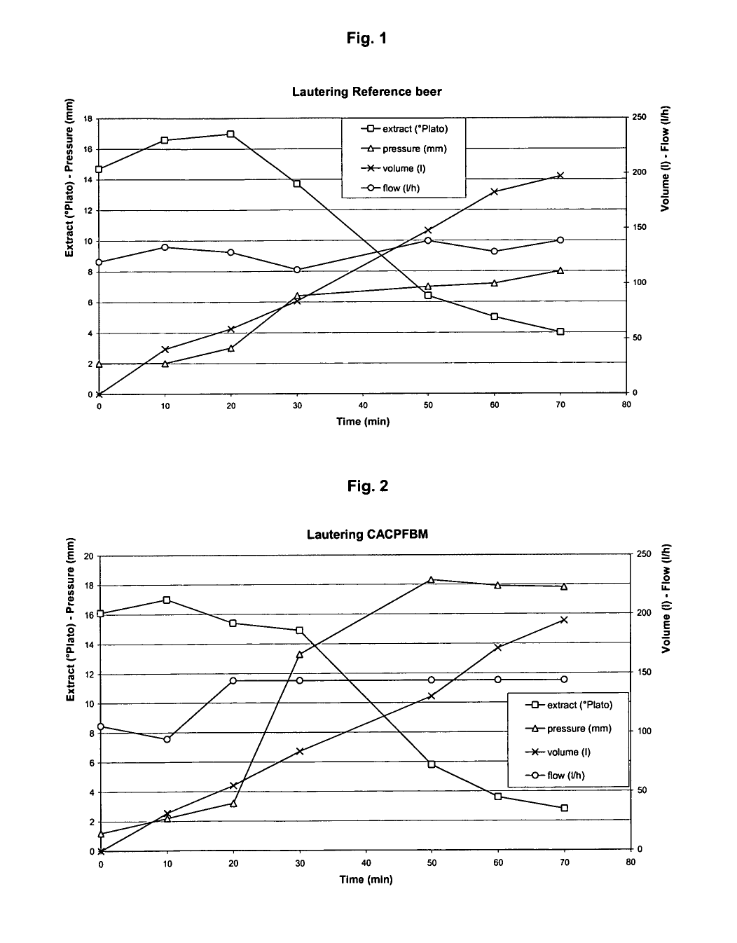

No remarkable differences were noticed during the wort production with or without cacao polyphenols. The sparging of the spent grains during wort lautering was a little bit more efficient with the addition of cacao polyphenols. The results for volume (l), extract (° Plato), pressure (mm), flow (s/l) and flow (l/h) are shown for the reference beer and CACPFBM in respectively FIG. 1 and FIG. 2.

An interesting parameter during wort production is the trub potential. In table 3 are the results for the two pilot brews. The brightness of the wort is of outmost importance for the taste and flavour stability of the beer.

TABLE 3
Trub potential during brewing

| Trub potential | First wort | Second wort | Pitching wort |
|---|---|---|---|
| REF | 10 ml | 0 ml | 4 ml |
| Cacpfbm | 1.8 ml | 1.2 ml | 2.5 ml |

The wort prepared with cacao polyphenols during wort production is brighter than the reference brew. Polyphenolic compounds co-precipitate with malt proteins during mashing resulting in an easier wort lautering and brighter worts.

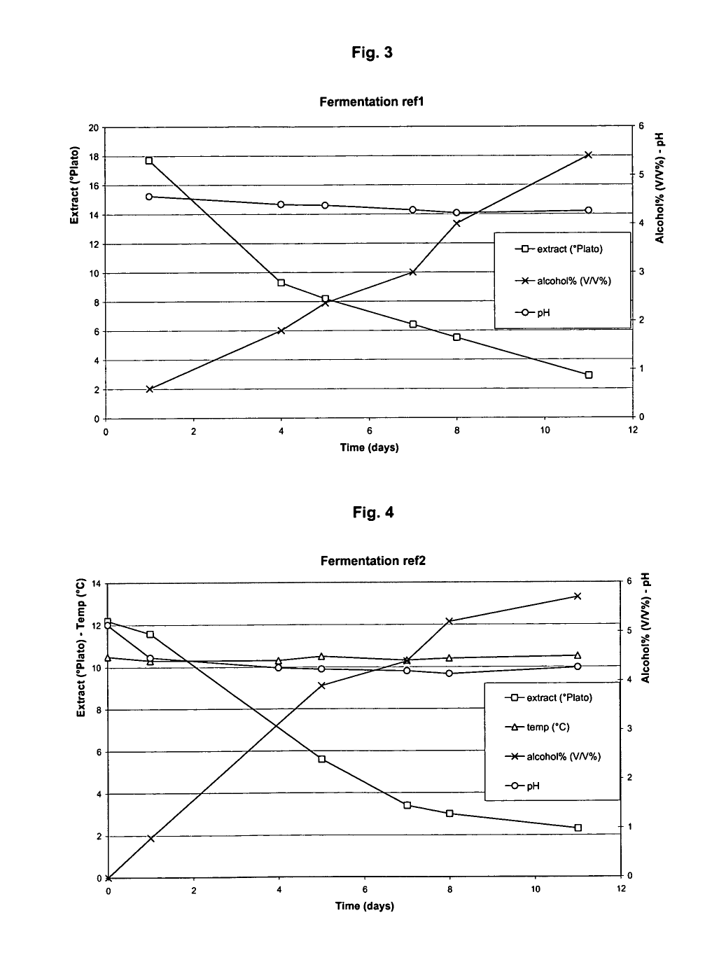

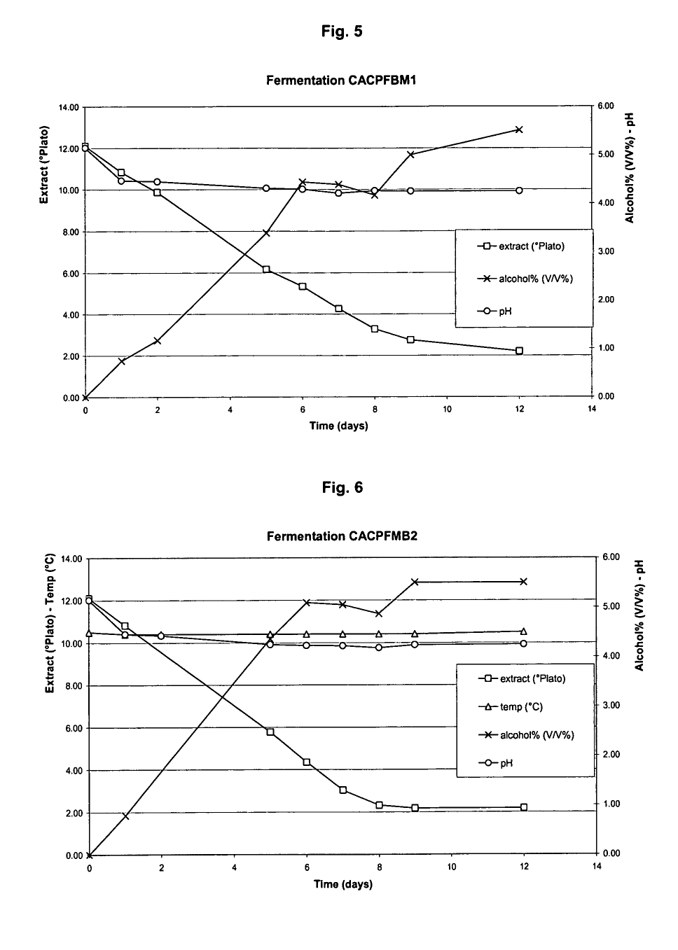

After lautering the wort was divided in three volumes. In two of these volumes several parameters such as extract (° Plato), alcohol % (V/V %), pH and temperature (° C.) were monitored during the subsequent wort fermentation. The detailed results of the two reference beers are shown in FIGS. 3 and 4, those of the two CACPFBM beers are shown in FIGS. 5 and 6.

### Polyphenolic Profiling of Beer (HPLC)

A polyphenolic fingerprinting of the different beers was analysed by HPLC. An overview of the amounts of polyphenolic markers in the beers is given in table 4.

TABLE 4
Polyphenolic profiling of the beers

| | concentration (mg/l) | | | |
|---|---|---|---|---|
| | REF | cacpfbm0 | cacpfbm10 | cacpfbm20 |
| prodelphinidine trimeer | 1.74 | 1.46 | 1.93 | 1.72 |
| prodelphinidine B3 | 8.51 | 4.14 | 5.79 | 7.86 |
| procyanidine trimeer | 3.34 | 1.55 | 2.10 | 2.90 |
| procyanidine B3 | 13.10 | 6.54 | 9.00 | 12.71 |
| (+)-catechin | 5.67 | 4.64 | 5.41 | 7.14 |
| (−)-epicatechin | 1.36 | 0.85 | 1.04 | 1.24 |
| p-coumaric acid | 0.39 | 0.30 | 0.34 | 0.43 |
| ferulic acid | 0.68 | 0.81 | 0.94 | 1.13 |

A significant lower amount of polyphenols is found in the cacpfbm 0 beer compared to the reference beer. The cacpfbm 0 beer was the first beer for the filtration process. This means more absorption of beer compounds (in particular proteins and polyphenols) during the beer filtration. Higher amounts of polyphenolic compounds were found in beers with extra addition of cacao polyphenols post fermentation.

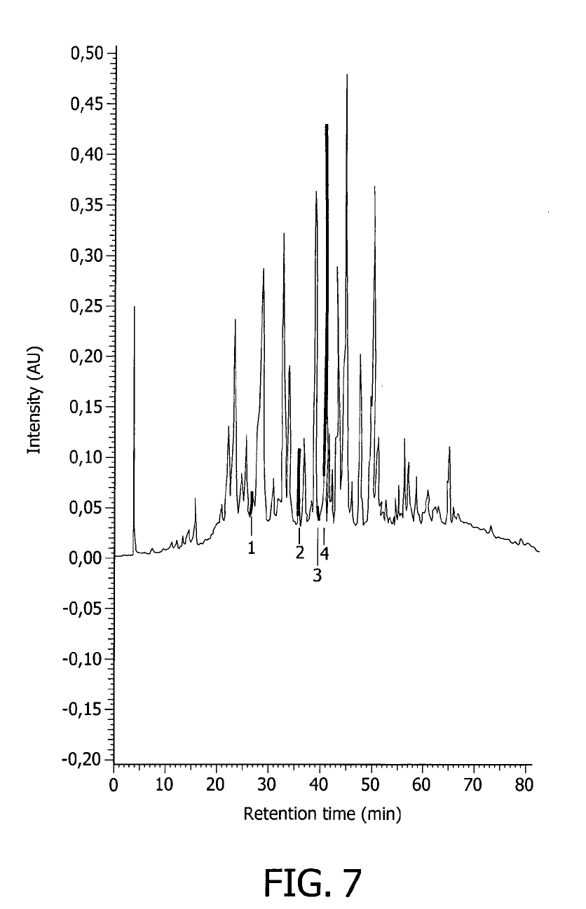

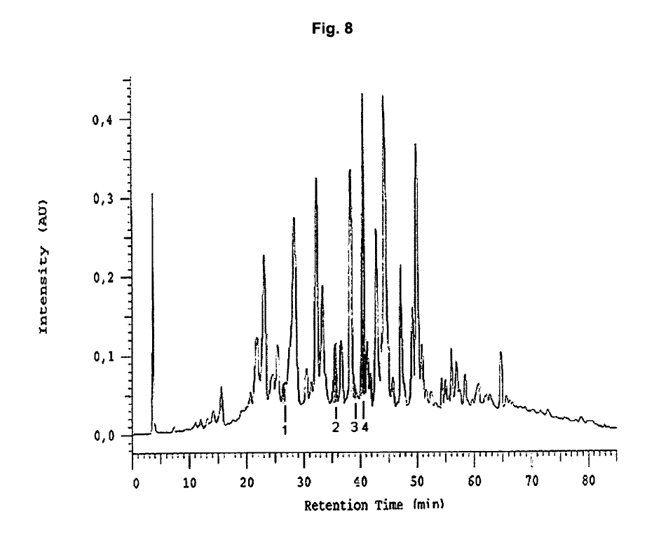

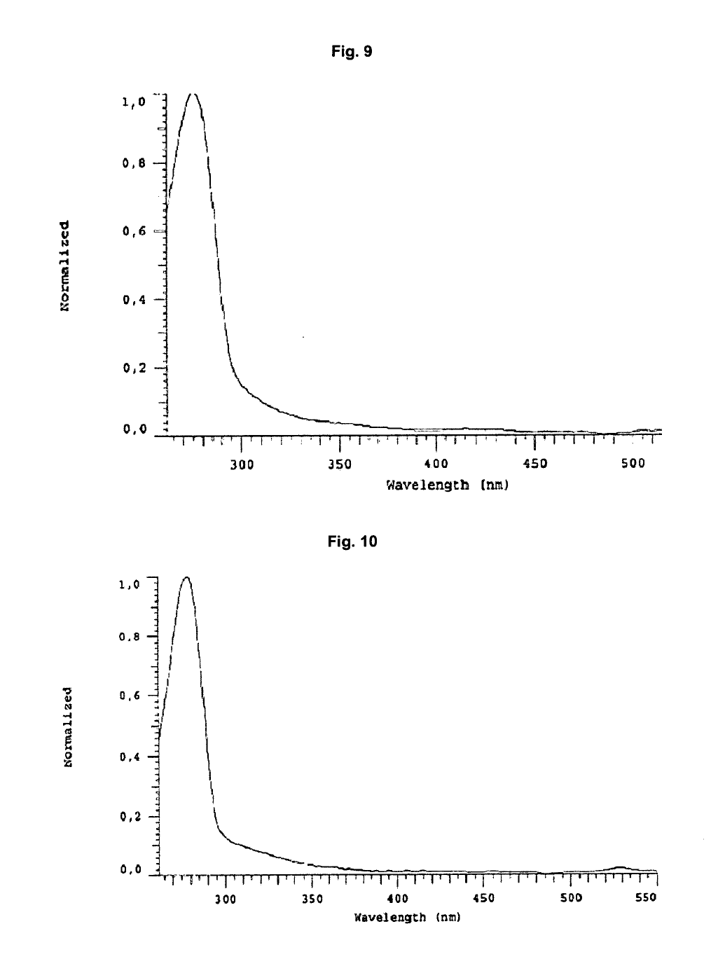

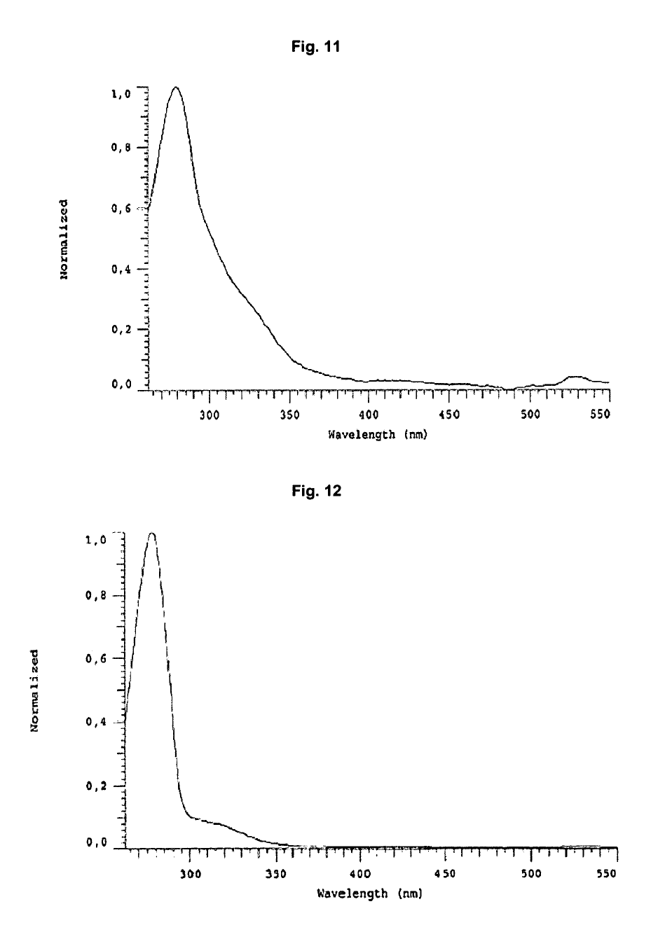

The chromatograms, detection at 280 nm, of the reference beer and the cacpfbm 20 beer were shown in FIGS. 7 and 8. Also the DAD spectra of the cacao polyphenols were shown in FIGS. 9 to 12.

The flavonoids (DAD spectra polyphenols FIGS. 9 to 12) are quantitatively the most important cacao polyphenols found in beer cacpfbm 20 (chromatogram b in FIG. 7).

FIG. 7 indicates that only the first polyphenol is derived from cacao. The other compounds were also found in the reference beer (chromatogram a in FIG. 7). Those compounds came from the malt. This is very important concerning the tracing of additives. The cacao polyphenols are very similar to the malt polyphenols.

### Determination of the Amount of Gallic Acid in the Beers

The amount of gallic acid is determined by a private method based on extraction with ethyl acetate and analysis by HPLC. The results are given in table 5.

TABLE 5
Amount of gallic acid in the beers

| | Gallic acid (ppm) |
|---|---|
| Reference | 2.06 |
| CACPFBM 0 | 1.28 |
| CACPFBM 10 | 1.96 |
| CACPFBM 20 | 1.33 |

The results of this analysis indicate that no gallic acid is introduced in the beer by the polyphenolic extract of cacao. The contribution of malt is 2 ppm gallic acid. The lower amount in CACPFBM 0 is due to adsorption to the beer filter, as previously explained.

### Standard Analysis of the Beers

The results of the analysis of the fresh and forced aged beers are summarized in table 6. The similar alcohol and extract concentrations indicate comparable fermentations of the beers (FIGS. 3 to 6). The formation of cold turbidity during beer ageing is lower in the beers with the addition of cacao polyphenols. Higher doses of cacao polyphenols however results in higher turbidity of the fresh beer. On the other hand, the permanent turbidity of the beers with cacao polyphenols is lower than the reference beer. This indicates less oxidative transformations in the beers with cacao polyphenols.

TABLE 6
Standard analyses of the beers

| | | REF | | cacpfbm0 | | cacpfbm10 | | cacpfbm20 | |
|---|---|---|---|---|---|---|---|---|---|
| | | | 60 d, | | 60 d, | | 60 d, | | 60 d, |
| | unit | fresh | 30° C. | fresh | 30° C. | fresh | 30° C. | fresh | 30° C. |
| Alcohol | ml/100 ml | 5.53 | 5.56 | 5.41 | 5.41 | 5.48 | 5.48 | 5.48 | 5.47 |
| Apparent extract | g/100 g | 2.26 | 2.31 | 2.14 | 2.12 | 2.17 | 2.19 | 2.22 | 2.21 |
| Real extract | g/100 g | 4.26 | 4.31 | 4.09 | 4.07 | 4.15 | 4.17 | 4.19 | 4.19 |
| Original extract | g/100 g | 12.63 | 12.72 | 12.3 | 12.28 | 12.45 | 12.48 | 12.5 | 12.48 |
| App degree of | % | 82.07 | 81.85 | 82.62 | 82.76 | 82.59 | 82.41 | 82.25 | 82.27 |
| fermentation | | | | | | | | | |
| Real degree of | % | 67.78 | 67.62 | 68.18 | 68.28 | 68.17 | 68.03 | 67.91 | 67.92 |
| fermentation | | | | | | | | | |
| FAN | mg/l | 83.5 | 84.6 | 112.4 | 110.0 | 109.6 | 109.4 | 104.0 | 105.1 |
| Soluble protein | mg/l | 534.7 | 498.7 | 373.2 | 341.2 | 460.2 | 431.2 | 513.7 | 448.2 |
| Sensitive protein | FHU | 9.4 | 10.9 | 7.4 | 7.1 | 6.4 | 6.9 | 5.6 | 5.3 |
| Cold turbidity | FHU | 4.81 | 17.69 | 0.60 | 2.50 | 0.79 | 7.07 | 1.08 | 10.14 |
| Permanent turbidity | FHU | 0.62 | 1.26 | 0.57 | 0.53 | 0.58 | 0.86 | 0.58 | 0.50 |
| foam stability (NIBEM) | s | 217 | 211 | 231 | 194 | 225 | 179 | 239 | 189 |
| pH | | 4.19 | 4.20 | 4.26 | 4.26 | 4.26 | 4.26 | 4.25 | 4.26 |
| Total polyphenols | mg/l | 181.2 | 169.3 | 139.4 | 139.8 | 176.7 | 180.8 | 193.5 | 196.0 |
| Total flavonoids | (+)catechin eq | 39.5 | 32.7 | 32.0 | 28.5 | 41.0 | 38.4 | 45.6 | 42.0 |
| Total proanthocyanidins | mg/l | 30.7 | 29.7 | 24.5 | 24.3 | 26.9 | 28.6 | 24.8 | 31.7 |
| Soluble O₂ in beer | ppb | 10 | 8 | 43 | 14 | 39 | 17 | 33 | 14 |
| TBA | (index for 100 ml beer) | 36.2 | 34.3 | 32.8 | 31.7 | 33.1 | 31.3 | 33.8 | 31.1 |
| reducing power TRAP | mM ascorbic acid | 1.156 | 1.126 | 1.033 | 0.984 | 1.167 | 1.149 | 1.233 | 1.198 |
| reducing power FRAP | mM FeSO₄ | 1.621 | 1.500 | 1.335 | 1.290 | 1.608 | 1.524 | 1.674 | 1.661 |
| | eq. | | | | | | | | |
| reducing power DPPH | ΔA (10 min) | 1.048 | 0.983 | 0.872 | 0.869 | 1.019 | 1.004 | 1.087 | 1.078 |
| THOE | ppm | 2.1 | 2.4 | 2.3 | 2.8 | 2.3 | 2.8 | 2.4 | 2.8 |

The foam stability is not influenced by the addition of cacao polyphenols. The foam proteins weren't removed by the addition of polyphenolic compounds.

The concentration of polyphenols in the reference beer is higher than the concentration in beer cacpfbm 0 due to more absorption during beer filtration. The amount of proanthocyanidins is higher in the reference beer (for the same reason), but the amount of flavonoids is higher in the beers with addition (post fermentation) of cacao polyphenols. This indicates the introduction of monomer flavonoids by using the cacao polyphenols. The reducing power of the beer (cfr TRAP, FRAP, DPPH) is directly correlated with the amount of total polyphenols.

The concentrations of trihydroxy fatty acids (THOE) are very low in all the beers compared with commercial beers (amounts between 8 and 14 ppm). This indicates no novo formation of trihydroxy fatty acids during brewing due to the high mashing-in temperature (63° C.) and low mashing-in pH (5.2). The trihydroxy fatty acids are intermediary products of the degradation of fatty acids into aldehydes (auto-oxidation or enzymatic with lipoxygenase). Some of those aldehydes are responsible for the aged flavour of beer.

### Degradation of Beer Bitterness During Ageing

The degradation of bitterness compounds of beer, iso-a-acids, is some considerable time a marker for the beer instability.

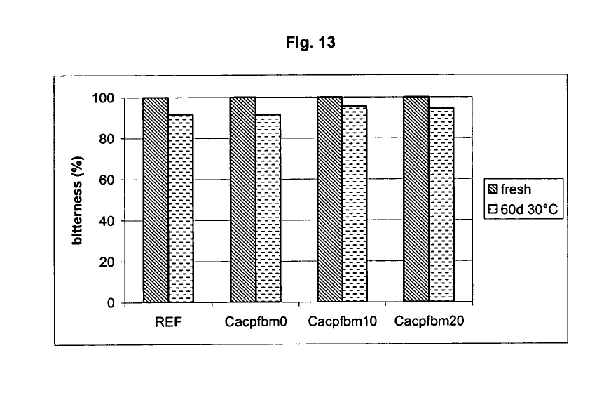

A stabilisation of the bitterness compounds is obtained when cacao polyphenols were added as shown in FIG. 13. Even with the lowest reducing power, the degradation of bitterness in the cacpfbm0 beer is comparable with the reference beer. This indicates a stabilisation by the addition of polyphenols during mashing because the finished beer cacpfbm0 contains less anti-oxidants.

An extra addition of cacao polyphenols at maturation results in an additional stabilisation, in particular the cis-isomers (table 9 and 10).

TABLE 7
Degradation of bitterness during ageing of the reference beer

| | fresh | | 60 d 30° C. | |
|---|---|---|---|---|
| | concentration | | concentration | |
| REF | (ppm) | % | (ppm) | % |
| t-iso-cohumulone | 2.74 | 100 | 1.98 | 72.14 |
| c-iso-cohumulone | 9.76 | 100 | 9.36 | 95.91 |
| t-iso-humulone | 2.42 | 100 | 1.81 | 74.79 |
| c-iso-humulone | 8.44 | 100 | 8.09 | 95.89 |
| t-iso-adhumulone | 0.79 | 100 | 0.67 | 84.13 |
| c-iso-adhumulone | 2.43 | 100 | 2.46 | 101.20 |
| total bitterness | 26.58 | 100 | 24.36 | 91.66 |

TABLE 8
Degradation of bitterness during ageing of cacpfbm0

| | fresh | | 60 d 30° C. | |
|---|---|---|---|---|
| Cacpfbm0 | concentration (ppm) | % | concentration (ppm) | % |
| t-iso- | 2.22 | 100 | 1.67 | 75.39 |
| cohumulone | | | | |
| c-iso- | 8.13 | 100 | 7.81 | 96.12 |
| cohumulone | | | | |
| t-iso-humulone | 1.77 | 100 | 1.37 | 77.20 |
| c-iso-humulone | 6.35 | 100 | 6.02 | 94.76 |
| t-iso- | 0.60 | 100 | 0.48 | 80.18 |
| adhumulone | | | | |
| c-iso- | 1.88 | 100 | 1.80 | 95.79 |
| adhumulone | | | | |
| total bitterness | 20.95 | 100 | 19.16 | 91.42 |

TABLE 9
Degradation of bitterness during ageing of cacpfbm10

| | fresh | | 60 d 30° C. | |
|---|---|---|---|---|
| | concentration | | concentration | |
| Cacpfbm10 | (ppm) | % | (ppm) | % |
| t-iso-cohumulone | 2.18 | 100 | 1.71 | 78.32 |
| c-iso-cohumulone | 8.01 | 100 | 8.11 | 101.30 |
| t-iso-humulone | 1.78 | 100 | 1.40 | 78.47 |
| c-iso-humulone | 6.37 | 100 | 6.39 | 100.30 |
| t-iso-adhumulone | 0.67 | 100 | 0.48 | 71.83 |
| c-iso-adhumulone | 1.91 | 100 | 1.90 | 99.43 |
| total bitterness | 20.92 | 100 | 19.99 | 95.55 |

TABLE 10
Degradation of bitterness during ageing of cacpfbm20

| | fresh | | 60 d 30° C. | |
|---|---|---|---|---|
| | concentration | | concentration | |
| Cacpfbm20 | (ppm) | % | (ppm) | % |
| t-iso-cohumulone | 2.35 | 100 | 1.77 | 75.61 |
| c-iso-cohumulone | 8.52 | 100 | 8.52 | 99.98 |
| t-iso-humulone | 1.95 | 100 | 1.48 | 75.63 |
| c-iso-humulone | 6.94 | 100 | 6.88 | 99.15 |
| t-iso-adhumulone | 0.65 | 100 | 0.51 | 78.00 |
| c-iso-adhumulone | 2.00 | 100 | 2.03 | 101.29 |
| total bitterness | 22.41 | 100 | 21.18 | 94.53 |

### Sensorial Evaluation of the Beer Ageing

The beer ageing was evaluated sensorial by the trained taste panel of KaHo St.-Lieven. The fresh beers with cacao polyphenols hadn't any off flavours. An ageing score from 0 (fresh) to 10 (very strongly aged-undrinkable) was given to fresh and the forced aged beers (30 days at 30° C.).

The different scores are summarized in table 11. The results indicate a less pronounced ageing of the beers with the addition of cacao polyphenols.

TABLE 11
Ageing scores of the beers

| | | ageing score aged beer |
|---|---|---|
| | ageing score of the fresh beer | (30 days at 30° C.) |
| REF | 0.15 | 6.08 |
| CACPFBM 0 | 0.46 | 5.15 |
| CACPFBM 10 | 0.00 | 4.58 |

TABLE 12
Descriptive sensorial evaluation

| | | | bitterness | bitterness |
|---|---|---|---|---|
| | astringency | fullness | intensity | quality |
| REF | 1.6 | 4.7 | 6.3 | 6.8 |
| CACPFBM 0 | 1.3 | 3.9 | 5.6 | 6.3 |
| CACPFBM 10 | 1.8 | 4.6 | 6.1 | 6.3 |

Also a score from 0 to 10 was given for some quality issues (table 12). Those tasting results are in line with the analytical results. The bitterness intensity of the reference beer was experienced a little bit more and the fullness in taste was the lowest (due to the lower polyphenol content) in the cacpfbm0 beer. The quality of the bitterness and the astringency was not affected by the addition of those concentrations of polyphenols.

### Example 2.2

### Beer Production

In this example three beer production techniques were applied, including a process
1. wherein hop pellets are applied during the brewing process,
2. wherein a CO₂ extract of hop in applied during the brewing process, and
3. wherein a iso-alpha extract of hop in applied during the brewing process.

Beer production techniques using this type of hop components are well known for a skilled person familiar with brewing techniques and will not be discussed in detail herein.

Using the three above-indicated techniques, reference beers were made, whereby no additional cocoa extract was added during the brewing process. These beers are denoted as cal.ref beers. Beers were also prepared wherein a cocoa extract according to the invention was added during the brewing process. These latter beers are denoted as calpel.pf beers, calco2.pf beers and caliso.pf beers. As indicated above for example 2.1, for the additions a cocoa extract having about of 35% (by weight) of polyphenols was added during the process.

The brewing conditions applied in this example differed slightly from those of the brewing process in example 2.1, as a low starting temperature of 45° C. and a high pH of 5.8 were used instead of the higher starting temperature of 63° C. and lower pH of 5.2 of the former example 2.1.

### Process Using Hop Pellets

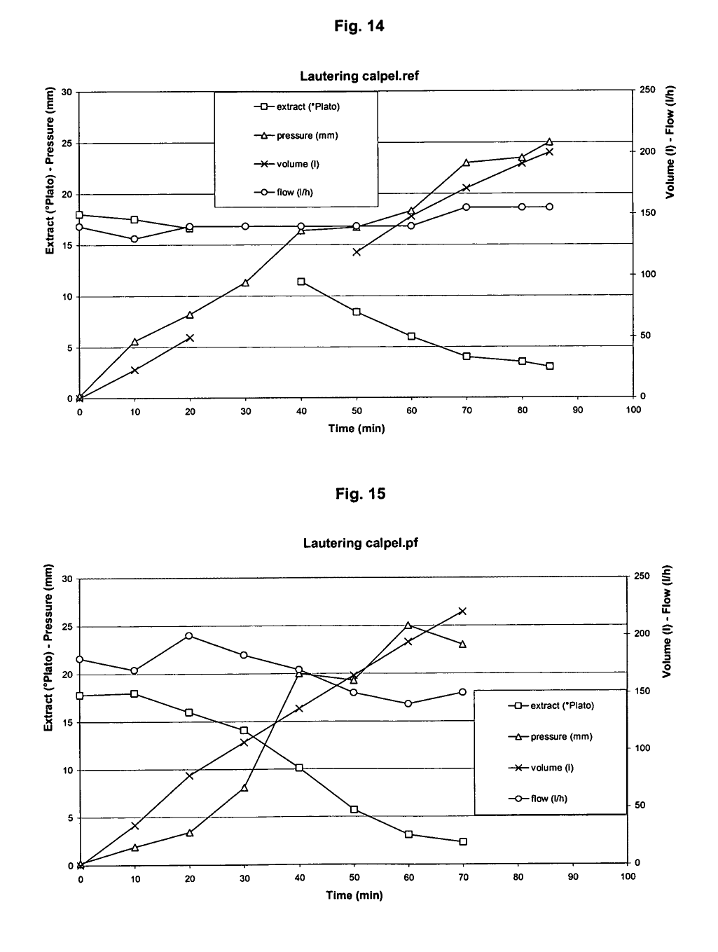

In the present beer production process hop pellets were added. Volume (l), extract (° Plato), pressure (mm) and flow (l/h) are monitored during wort lautering for the reference beer (calpel.ref) and the beer with cacao polyphenols (calpel.pf) and are displayed in respectively FIG. 14 and FIG. 15. As can be seen from these results, the sparging efficiency of the beer with added cacao polyphenols was somewhat higher than that of the reference beer.

The measurements of trub potential of both pilot brews are shown in table 13. As can be concluded from the lower values of the cacao polyphenol beer, this wort was brighter than the wort of the reference beer.

TABLE 13
Trub potential during brewing

| Trub potential | First wort | Second wort | Pitching wort |
|---|---|---|---|
| Calpel.ref | 1.2 ml | 0.5 ml | 3.5 ml |
| Calpel.pf | 0.2 ml | 0.1 ml | 1.0 ml |

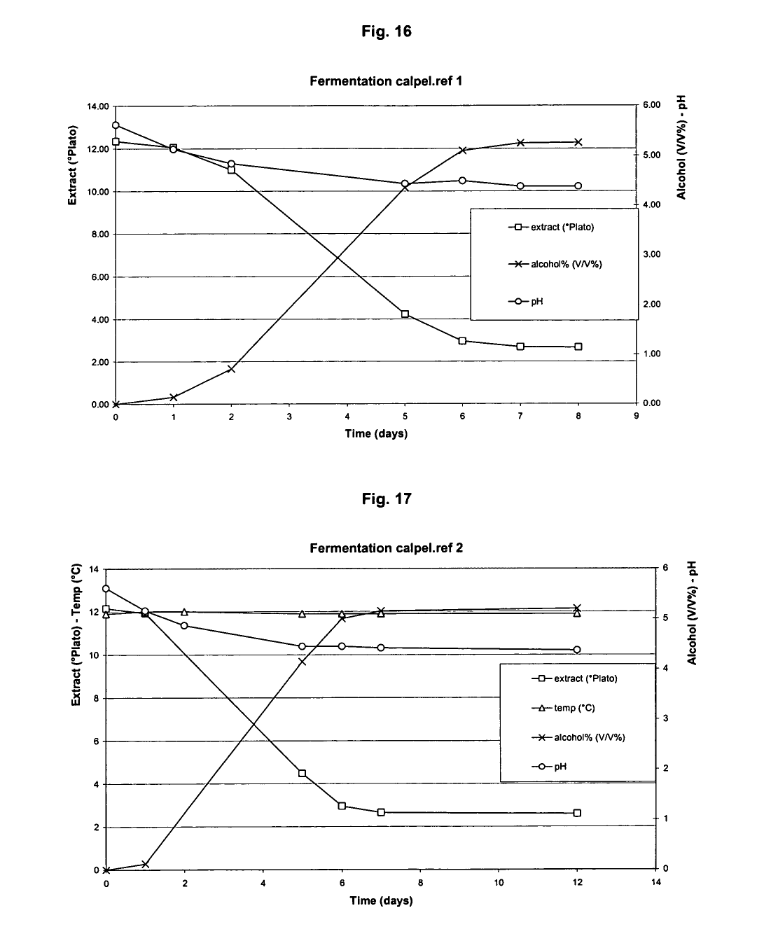

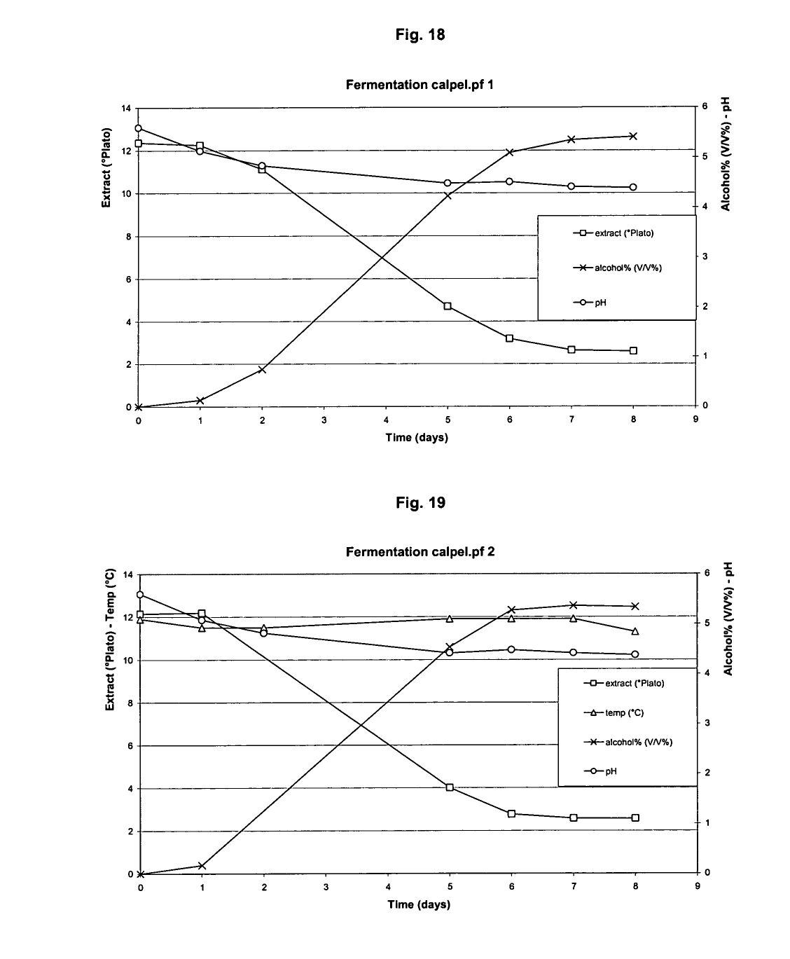

After lautering the wort was divided in three volumes. In two of these volumes several parameters such as extract (*Plato), alcohol % (V/V %), pH and temperature (° C.) were monitored during the subsequent wort fermentation. The detailed results of the two reference beers are shown in FIGS. 16 and 17, those of the two calpel.pf beers are shown in FIGS. 18 and 19.

### Process Using a CO Extract of Hop

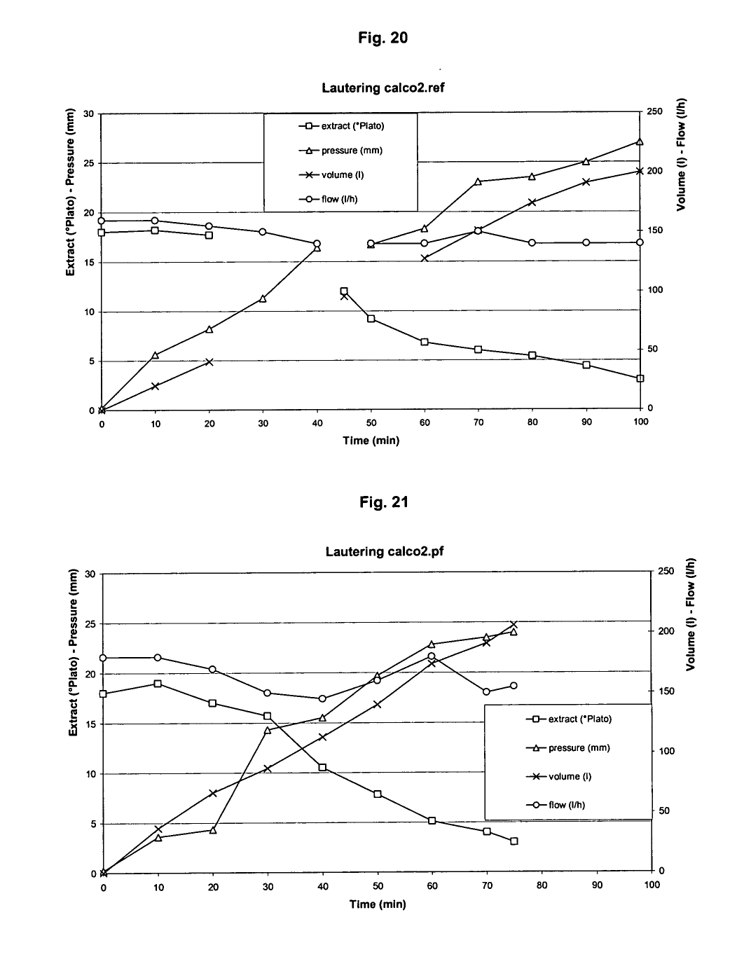

In this process a hop CO₂ extract was added having a final concentration of 25 ppm. Volume (l), extract (*Plato), pressure (mm) and flow (l/h) were measured during wort lautering and the results are shown for the reference beer (calco2.ref) in FIG. 20 and for the beer with addition of cacao polyphenols (calco2.pf) in FIG. 21. The pressure and flow results of the cacao polyphenol beer were slightly higher during sparging than those of the reference beer, indicating a higher efficiency of the former.

The trub potential of the wort with cacao polyphenols was in every stage smaller than that of the standard wort, as can be seen in table 14, which shows that the wort with cacao polyphenols was clearer than the reference wort.

TABLE 14
Trub potential during brewing

| Trub potential | First wort | Second wort | Pitching wort |
|---|---|---|---|
| Calco2.ref | 1.5 ml | 5 ml | 3.5 ml |
| Calco2.pf | 0.2 ml | 0.2 ml | 1.0 ml |

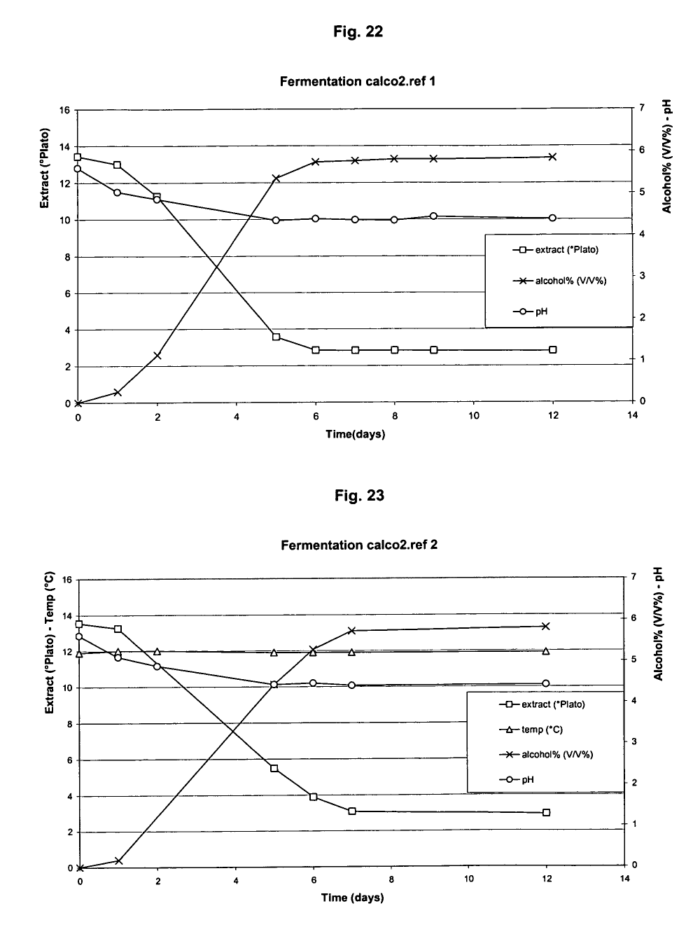

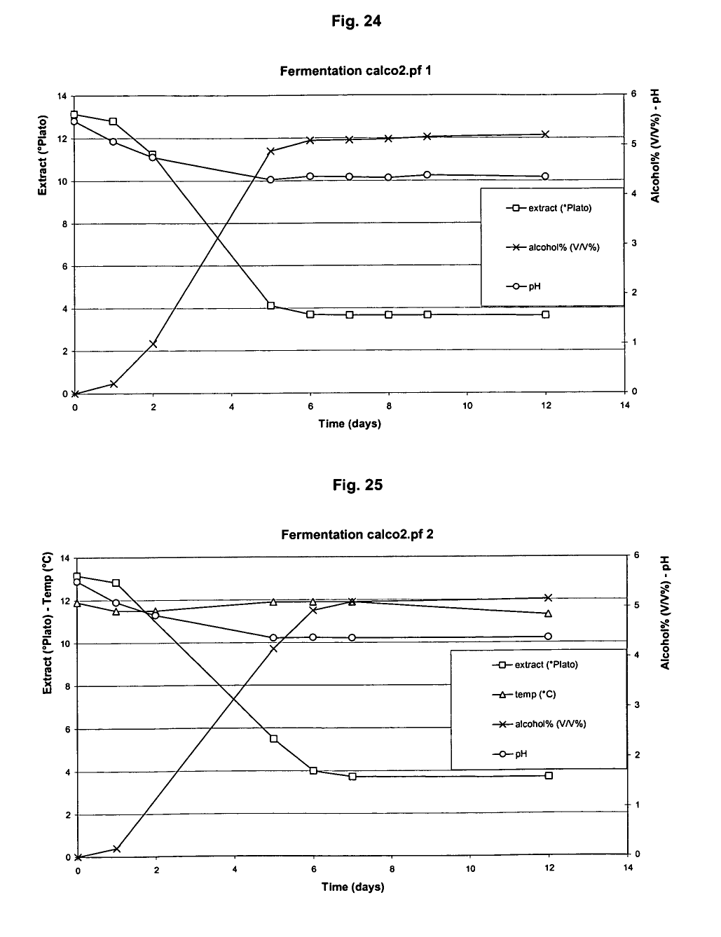

After lautering the wort was divided in three volumes. In two of these volumes several parameters such as extract (*Plato), alcohol % (V/V %), pH and temperature (° C.) were monitored during the subsequent wort fermentation. The detailed results of the two reference beers are shown in FIGS. 22 and 23, those of the two calco2.pf beers are shown in FIGS. 24 and 25.

### Process Using an Iso-Alpha-Extract of Hop

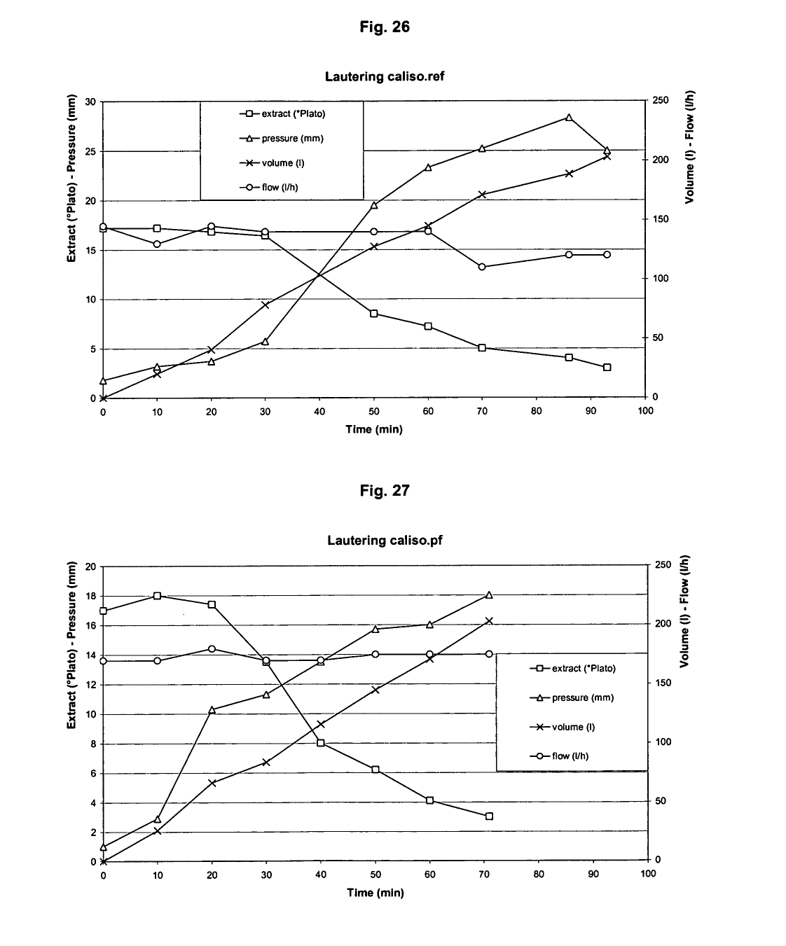

Hop is added as an iso-a-extract with a resulting concentration of 25 ppm. As in the previous processes, volume (l), extract (° Plato), pressure (mm) and flow (l/h) were monitored during wort lautering. The results for the reference beer (caliso.ref) and the beer with added cacao polyphenols (caliso.pf) are shown in respectively FIG. 26 and FIG. 27. Although the pressure was slightly lower during filtration of the cacao polyphenol wort than that of the reference beer, the flow of the former was higher than that of the latter during the entire wort lautering, indicating a more efficient filtration of the first wort supplemented with the cacao polyphenols in comparison to the reference wort.

The trub potential of both pilot brews is shown in table 15. The lower values of the worts supplemented with cacao polyphenols indicate that these worts are brighter than the reference worts.

TABLE 15
Trub potential during brewing

| Trub potential | First wort | Second wort | Pitching wort |
|---|---|---|---|
| Caliso.ref | 0.5 ml | 5 ml | 3.5 ml |
| Caliso.pf | 0 ml | 0.4 ml | 0.5 ml |

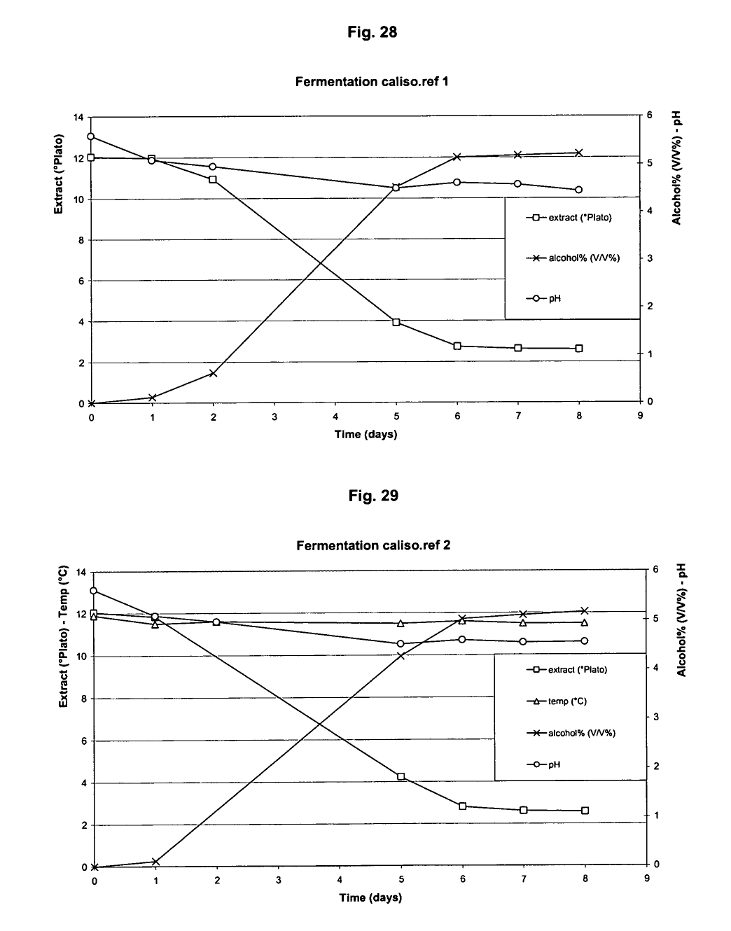

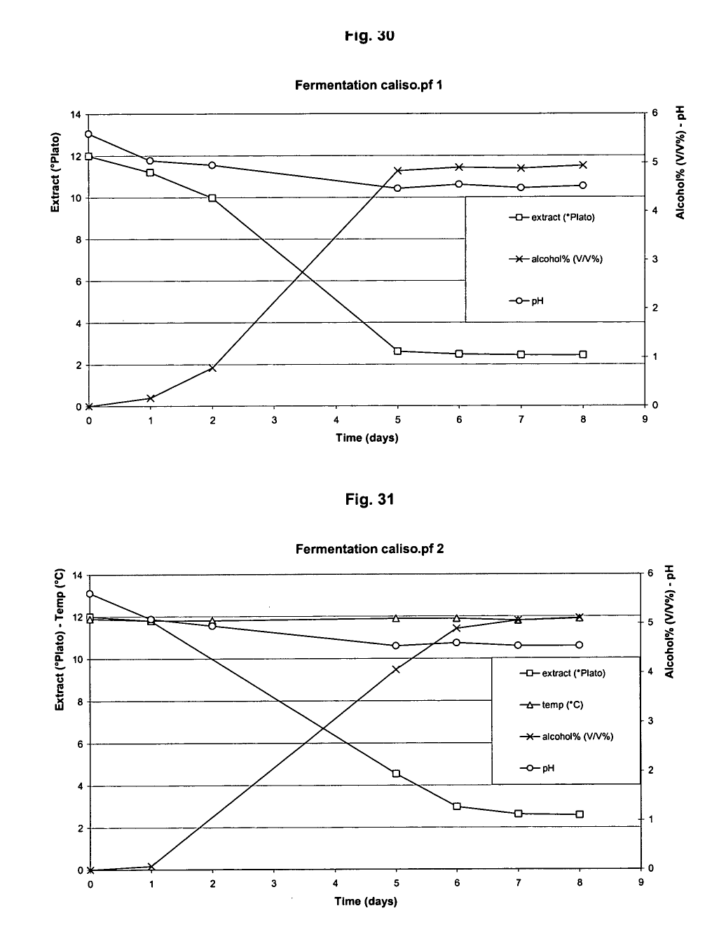

After lautering the wort was divided in three volumes. In two of these volumes several parameters such as extract (° Plato), alcohol % (V/V %), pH and temperature (° C.) were monitored during the subsequent wort fermentation. The detailed results of the two reference beers are shown in FIGS. 28 and 29, those of the two caliso.pf beers are shown in FIGS. 30 and 31.

The present example illustrates that addition of a cocoa extract during the beer brewing process enables to obtain brighter worts. The present example also clearly shows that addition of a cocoa extract also permits to lower the trub potential. Preferably, at the end of the wort filtration the extract has a value of about 3° Plato, which is an indication of the amount of fermentable sugars. The present examples illustrates that beer having good flavour stability can be advantageously obtained using three different beer brewing processes, commonly known in the industry.

### Example 2.3

### Cocoa Extract Having Reduced Amounts of Xanthines and Theobromines

The following example illustrates a method according to the invention for reducing or removing theobromines and/or xanthines present in a cocoa extract. For this, a cocoa extract containing polyphenols and xanthines is treated in a supercritical CO₂ reactor (500 ml SEPAREX) according to the following method.

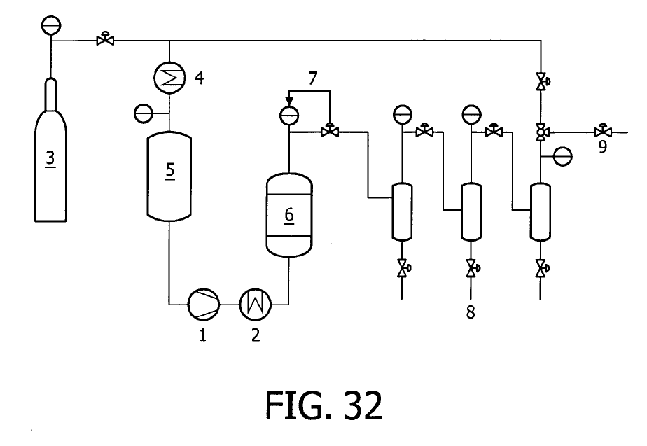

In the supercritical CO₂-extractor cooled, liquid CO₂ is pressed by means of a high pressure pump or compressor (1) above the critical pressure (p>73.8 bar), and subsequently heated above the critical temperature (T>31.1° C.) in a heater (2) as illustrated on FIG. 32 to obtain supercritical conditions. Reference number (3), (4) and (5) in FIG. 32 refer to a CO₂ cylinder, a condenser and a CO₂ container, respectively. The scCO₂ flows through a heated extraction vessel (6), in which a cocoa extract according to the invention (in powder or flake form) is provided. The scCO₂ dissolves the theobromine out of the cocoa extract. After leaving the extraction vessel the scCO₂ is relaxed over a pressure restrictor (7), and CO₂ is separated from extracted theobromine in a number of separators (8). The CO₂ at the exit of the last separator is or directly ventilated or is re-used by liquefying it again. Reference sign (9) refers to a ventilation conduct. The extracted components, mainly theobromine, are collected at the bottom of the separators. By adapting the extraction conditions theobromine can be extracted. Here a cocoa extract having a lower theobromine content is made. If there is still a remaining fat fraction, this fraction can be separated together with the xanthines.

During the experiment, the SEPAREX-extractor with a content of 500 ml was loaded with 80 g product (cocoa extract). The reactor is brought on 70° C. and the extraction will be performed at 250 bar, and with 10 weight % ethanol in CO₂. The ethanol is a co-solvent of the CO₂. As the co-solvent is limited in capacity (2 kg/h) the total flow over the reactor is limited to 13.3 kg/h (=12 kg/h CO₂ and 1.3 kg/h ethanol). After extraction with ethanol as co-solvent, a flushing with pure CO₂ (D_{CO2}=13.3 kg/h) during 1.5 h was done at the same process conditions to obtain a dry product.

Before extraction the cocoa extract contained 47.3% polyphenols (mainly flavan-3-ols and procyanidins), 8.16% xanthines and 7.45% theobromine. After extraction with CO₂ and ethanol as a co-solvent the dry cocoa extract contained 51.2% polyphenols (mainly flavan-3-ols and procyanidins), 3.55% xanthines and 3.32% theobromine. The amount of polyphenols increased without effecting the polyphenol composition, the theobromine content decreased more than 50%.

The present example illustrates that according to the present invention, a cocoa extract can be prepared having reduced amounts of xanthines and theobromine.

### GENERAL CONCLUSIONS

The use of cacao polyphenols at mashing-in has some clear benefits.

A brighter wort was obtained during wort lautering. This is favourable for the taste stability and colloidal stability of the beer. Also the wort filtration performance is influenced positively by the adsorption of sensitive proteins and less oxidation of gel proteins. No influence on the fermentation was noticed.

The analytical data indicate a positive effect of the addition of cacao polyphenols at mashing-in and post fermentation on the flavour stability of beer. Also the colloidal stability was positively influenced with the addition of polyphenols. A slight increase of the cold turbidity was noticed in the beers with an extra polyphenol addition at maturation. The permanent haze, as an indicator of oxidative transformations, is lower with higher amounts of polyphenols. The foam stability was not affected by the addition of polyphenols. A reduction of the degradation of bitterness compounds was noticed by using cacao polyphenols.

Also the sensorial evaluation of the beers confirms the analytical data with better ageing scores for the beers with cacao polyphenols. The taste was not negatively affected by the addition of cacao polyphenols in this concentration.

Cacao polyphenols can be a good tool in the brewing industry to improve the flavour stability. The polyphenols are very similar to those derived from malt, which is important for the labelling of additives. An extra colloidal stabilisation on the protein site will be necessary.

It can be further concluded that the cocoa extract according to the invention and as defined herein, when used during the brewing process, and in particular during mashing-in process and wort filtration fives a very pure and fresh beer taste. It also provides better lautering performance. Using the present cocoa extract during lautering reduces the risk of blocking the filter and results in interesting cost saving and increased capability (e.g. 20 to 25% reduction on filtration time) which may result in 12 instead of 10 brewings a day. Advantageously, no extract residues are left in the final beer and the present extract is active during brewing and can be completely removed after filtration. The present extract provides increased reducing power and sensory and analytical results confirm that increasing the reducing and anti-oxidant power by addition of the cocoa extract during brewing results in an improvement of the flavour stability of beer. Additional benefits of the present cocoa extract include a clearer wort, improved colloidal stability and addition of the present cocoa extract during brewing results in a similar foam stability and color of the final beers.

Use of the present cocoa extract for preparing beer also permits to prepare beer with reduced amounts of theobromines and/or xanthines in the beer.

1. Solvent-derived, cocoa extract comprising between 25 and 75% by weight of polyphenols, whereby said polyphenols comprise between 5 and 15% by weight of the cocoa extract of monomers and more than 20% by weight of the cocoa extract of one or more oligomers.

2. Cocoa extract according to claim 1, wherein said monomers comprise between 5 and 15% by weight of the extract of epicatechin and between 0.5 and 5% by weight of the extract of catechin.

3. Cocoa extract according to claim 1 or 2, wherein said oligomers comprise dimer(s), trimer(s), tetramer(s), pentamer(s), hexamer(s), heptamer(s), octamer(s), nonamer(s) and/or decamer(s).

4. Cocoa extract according to any of claims 1 to 3, wherein said oligomers comprise (% by weight of the extract) between 5 and 15% by weight of dimers, between 5 and 15% by weight of trimers, between 2.5 and 10% by weight of tetramers, between 2.5 and 10% by weight of pentamers, between 2.5 and 10% by weight of hexamers, between 0.5 and 5% by weight of heptamers, between 0.5 and 5% by weight of octamers, between 0.5 and 5% by weight of nonamers, and/or between 0.1 and 3% by weight of decamers.

5. Cocoa extract according to any of claims 1 to 4, wherein said solvent is ethanol and water, acetone and water, 2-butanol and water or 2-propanol and water.

6. Cocoa extract according to any of claims 1 to 5, wherein said extract further comprises between 5 and 15% by weight of one or more alkaloid(s).

7. Cocoa extract according to any of claims 1 to 6, wherein said extract contains less than 10 and preferably less than 5% by weight of xanthines.

8. Cocoa extract according to any of claims 1 to 7, wherein said extract contains less than 10 and preferably less than 5% by weight of theobromine.

9. Cocoa extract according to any of claims 1 to 8, wherein said extract further comprises between 5 and 15% by weight of one or more sugar(s) and/or sugar alcohol(s).

10. Cocoa extract according to any of claims 1 to 9, wherein said extract further comprises between 15 and 25% by weight of one or more protein(s).

11. Cocoa extract according to any of claims 1 to 10, wherein said extract further comprises between 3 and 10% by weight of one or more fiber(s).

12. Cocoa extract according to any of claims 1 to 11, wherein said extract is in a dry or lyophilized form, and preferably in the form of granules, pellets, or a powder.

13. Method for improving a beer production process and the resulting beer product which comprises addition of a cocoa extract according to any of claims 1 to 12, in one or more stages of the brewing process.

14. A method according to claim 13, characterized in that the cocoa extract is added prior to or at mashing and lautering.

15. A method according to claim 13, characterized in that the cocoa extract is added post fermentation.

16. A method according to claim 13, characterized in that the cocoa extract is added prior to or at mashing and lautering, and post fermentation.

17. A beer product obtainable by the method according to any of claims 13 to 16, characterized in that said beer product has an improved quality such as an enhanced colloidal, taste and/or flavor stability.

18. Beer product according to claim 17, having an amount of 0.1 to 100 ppm, and preferably 1 to 50 ppm cocoa polyphenols.

19. Beer product according to claim 17 or 18, having an amount of theobromine below 5 ppm, preferably below 3 ppm, and more preferably below 1 ppm.

20. Beer product according to any of claims 17 to 19, having an amount of xanthines below 5 ppm, preferably below 3 ppm, and more preferably below 1 ppm.

21. Use of a cocoa extract as claimed in any of claims 1 to 12, for improving a beer production process and the resulting beer product.

22. Use of a cocoa extract as claimed in any of claims 1 to 12, for improving wort filtration during the beer production process.

23. Use of a cocoa extract according to claim 22, for reducing the wort filtration time during the beer production process with at least 10%.

24. Use of a cocoa extract as claimed in any of claims 1 to 12, for preparing a beer product having a reduced amount of xanthines and/or theobromine.
